(19) United States
(12) Patent Application Publication
(10) Pub. No.: US 2013/0176288 A1
(43) Pub. Date: Jul. 11, 2013

(54) ELECTRONIC LABEL SYSTEM

(71) Applicant: SiPix Technology Inc., Taoyuan County (TW)

(72) Inventors: Chi-Mao Hung, Hsinchu City (TW); Ming-Jong Jou, Hsinchu City (TW); Wei-Min Sun, Taipei City (TW); Yao-Jen Hsieh, Hsinchu County (TW)

(73) Assignee: SIPIX TECHNOLOGY INC., Taoyuan County (TW)

(21) Appl. No.: 13/736,072

(22) Filed: Jan. 8, 2013

(30) Foreign Application Priority Data
Jan. 10, 2012 (TW) 101100955

(51) Int. Cl. H04B 7/00

(52) U.S. Cl. CPC H04B 7/00
USPC 345/204; 345/2.3

(57) ABSTRACT

An electronic label system, which includes a control unit, a first net unit, a second net unit and a plurality of electronic label units is provided. The control unit is configured for sending out a display information. The first net unit is coupled to the control unit for converting the display information into a wireless display signal. The second net unit is coupled to the first net unit for receiving the wireless display signal and outputting a display control signal. The electronic label units are coupled in series to the second net unit to receive the display control signal and to respectively display according to the corresponding display control signal. In this way, the cost of the electronic label system is reduced.

### CROSS-REFERENCE TO RELATED APPLICATION

This application claims the priority benefit of Taiwan application serial no. 101100955, filed on Jan. 10, 2012. The entirety of the above-mentioned patent application is hereby incorporated by reference herein and made a part of this specification.

### BACKGROUND OF THE INVENTION

1. Field of the Invention

The invention generally relates to an electronic system, and more particularly, to an electronic label system.

2. Description of Related Art

In recent years, the display is broadly used in consumer products, for example, it is increasingly demanded by, for example, e-signage, e-tag, e-book, smart card and e-POP. In particular, when the wireless constructions and digital science and technology become mature day by day, the display has become a vital electronic product.

In an electronic label system, the control unit thereof usually transmits messages to each of label nodes through a wireless signal, while each the label node displays according to the received message, so that each label node can be disposed as will without wiring issue. However, since the messages are transmitted between the control unit and each the label node through the wireless signal, the cost of the electronic label system is accordingly increased, which results in a lower chance to select the electronic label system for use. In this regard, how to reduce the cost of the electronic label system becomes one of important issues to be improved for the relevant manufactures.

### SUMMARY OF THE INVENTION

Accordingly, the invention is directed to an electronic label system, which uses a wired network to replace partial wireless network so as to reduce the hardware cost thereof.

The invention provides an electronic label system, which includes a control unit, a first net unit, a second net unit and a plurality of electronic label units. The control unit is configured for sending out a display information. The first net unit is coupled to the control unit for converting the display information into a wireless display signal. The second net unit is coupled to the first net unit for receiving the wireless display signal and outputting a display control signal. The electronic label units are coupled in series to the second net unit to receive the display control signal and to respectively display according to the corresponding display control signal.

In an embodiment of the present invention, each of the electronic label units includes a network connection unit and a display unit. The network connection unit of each of the electronic label units is coupled to the network connection unit of the adjacent electronic label unit or the second net unit. The display unit is coupled to the network connection unit to receive the display control signal through the network connection unit and display according to the display control signal.

In an embodiment of the present invention, the above-mentioned display unit includes a display panel and a driving circuit. The driving circuit is coupled to the display panel and the network connection unit to drive the display panel according to the display control signal.

In an embodiment of the present invention, the above-mentioned display panel is one of a liquid crystal display panel and an electrophoretic display panel.

In an embodiment of the present invention, the above-mentioned electronic label units are respectively corresponding to an address.

In an embodiment of the present invention, the above-mentioned second net unit sends out an address setting instruction and a starting address so that the electronic label units sequentially set the corresponding address respectively according to the coupling relationship.

In an embodiment of the present invention, the address range of the electronic label units are corresponding to the quantity of connected address lines of the electronic label units.

In an embodiment of the present invention, the above-mentioned electronic label units are respectively corresponding to a fixed address.

In an embodiment of the present invention, the above-mentioned first net unit is coupled to the control unit through one of an Ethernet network, an internal integrated circuit (I2C) interface, a serial peripheral interface (SPI), an RS232 interface and an ARM bus.

In an embodiment of the present invention, the above-mentioned control unit is coupled to a server through the Ethernet network so as to obtain the display information corresponding to each of the electronic label units from the server.

In an embodiment of the present invention, the above-mentioned server is coupled to a database through a virtual private-area network so as to update the display information corresponding to each of the electronic label units through the database.

In an embodiment of the present invention, the above-mentioned virtual private-area network is established in wide-area network.

In an embodiment of the present invention, the above-mentioned second net unit is coupled to the first net unit through one of a WiFi protocol, a ZigBee protocol and a third generation (3G) mobile communications protocol.

In an embodiment of the present invention, the above-mentioned electronic label units are coupled in series to the second net unit through one of an internal integrated circuit (I2C) interface, a serial peripheral interface (SPI), an RS232 interface and an ARM bus.

Based on the description above, the electronic label system in the embodiment uses a wired communication interface as the communication interface between the second net unit and the electronic label units so as to reduce the cost of the electronic label system.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic system diagram of an electronic label system according to an embodiment of the invention.

FIG. 2 is a schematic circuit diagram of an electronic label unit according to an embodiment of the invention.

### DESCRIPTION OF THE EMBODIMENTS

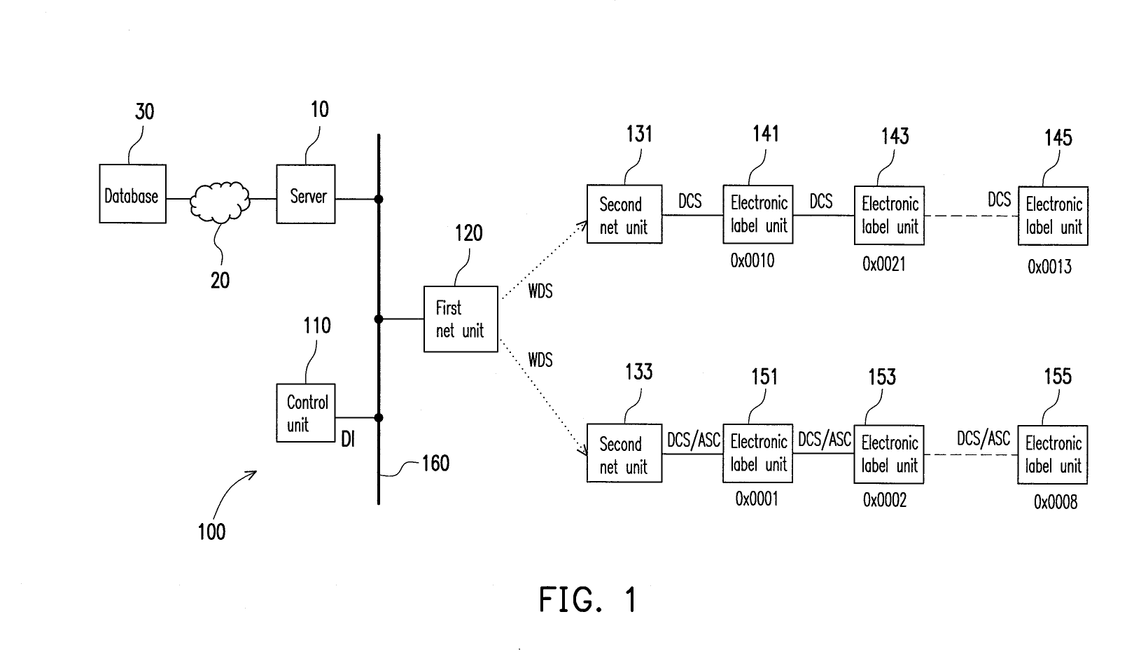

FIG. 1 is a schematic system diagram of an electronic label system according to an embodiment of the invention. Referring to FIG. 1, in the embodiment, an electronic label system 100 includes a control unit 110, a first net unit 120, two second net units 131 and 133 and a plurality of electronic label units (such as 141, 143, 145, 151, 153 and 155). The control unit 110 is for sending out a display information DI. The first net unit 120 is coupled to the control unit 110 through a line 160 to convert the display information DI into a wireless display signal WDS. The second net units 131 and 133 are coupled to the first net unit 120 for receiving the wireless display signal WDS and outputting a display control signal DCS.

The electronic label units 141, 143 and 145 are coupled in series to the second net unit 131 for receiving the display control signal DCS and respectively displaying according to the corresponding display control signal DCS. The electronic label units 151, 153 and 155 are coupled in series to the second net unit 133 for receiving the display control signal DCS and respectively displaying according to the corresponding display control signal DCS. In some embodiments, the second net units 131 and 133 are able to display, so that the second net units 131 and 133 can display according to the corresponding display control signal DCS.

In the embodiment, the electronic label units 141, 143, 145, 151, 153 and 155 are respectively corresponding to an address, and the display information DI (corresponding to the display control signal DCS) also contains an address information so that the electronic label units 141, 143, 145, 151, 153 and 155 can identify and receive the corresponding display control signal DCS. For example, if the display information DI contains an address information of 0×0010, the corresponding display control signal DCS is corresponding to the electronic label unit 141 and the electronic label unit 141 would display according to the corresponding display control signal DCS.

Taking the electronic label units 141, 143 and 145 as an example, the display control signal DCS can be simultaneously sent to the electronic label units 141, 143 and 145; or the display control signal DCS is sent to the electronic label unit 141 first, and if the display control signal DCS is not corresponding to the electronic label unit 141, the display control signal DCS would be sent to the electronic label unit 143 from the electronic label unit 141, and analogically for the rest. In addition, the address range of the electronic label units 141, 143, 145, 151, 153 and 155 is corresponding to the quantity of the connected address lines of the electronic label units 141, 143, 145, 151, 153 and 155. For example, if the quantity of the address lines is 3, the address range is 0×0000(0)−0×0007(7); if the quantity of the address lines is 10, the address range is 0×0000(0)−0×03FF(1023).

In addition, the addresses of the electronic label units 141, 143, 145, 151, 153 and 155 can be a fixed address or assigned according to the coupling relationship. In the embodiment, assuming the addresses of the electronic label units 141, 143 and 145 are fixed addresses, i.e., three addresses of 0×0010, 0×0021 and 0×0013 are respectively written to the electronic label units 141, 143 and 145 during fabrication. In the embodiment, assuming the addresses of the electronic label units 151, 153 and 145 are automatically assigned, then after starting, the second net unit 133 sends an address setting instruction ASC and a starting address (for example, 0×0001) to the electronic label unit 151 to set the address of the electronic label unit 151 as 0×0001; next, the electronic label unit 151 sends an address setting instruction ASC and a starting address 0×0002 (i.e., 0×0001+1) to the electronic label unit 153 to set the address of the electronic label unit 153 as 0×0002; in this way, if the electronic label unit 155 is the eighth electronic label unit, the address of the electronic label unit 155 is set as 0×0008.

In an embodiment of the invention, the line 160 can be an Ethernet line, i.e., the first net unit 120 is coupled to the control unit 110 through the Ethernet network, but in other embodiments, the line 160 can be an internal integrated circuit (I2C) interface circuit, a serial peripheral interface (SPI) circuit, an RS232 interface circuit or an ARM bus line. The wireless display signal WDS can be a wireless signal which conform to one of the WiFi protocol, ZigBee protocol and third generation (3G) mobile communications protocol or one of RF wireless signals of other types, i.e., the second net units 131 and 133 can be coupled to the first net unit 120 through one of a WiFi protocol, a ZigBee protocol and a third generation (3G) mobile communications protocol. The electronic label units 141, 143 and 145 are coupled in series to the second net unit 131 through one of the internal integrated circuit (I2C) interface circuit, the serial peripheral interface (SPI) circuit, the RS232 interface circuit and the ARM bus line, and in the same way, the electronic label units 151, 153 and 155 are coupled in series to the second net unit 133 through one of the internal integrated circuit (I2C) interface circuit, the serial peripheral interface (SPI) circuit, the RS232 interface circuit and the ARM bus line.

In the embodiment, the control unit 110 is coupled to the server 10 through the line 160 so as to obtain the display data corresponding to the electronic label units 141, 143, 145, 151, 153 and 155 from the server 10, and at the time, the display informations DI (corresponding to the display control signal DCS) corresponding to the electronic label units 141, 143, 145, 151, 153 and 155 are generated. Moreover, the server 10 can be coupled to the database 30 through a virtual private-area network 20 established in wide-area network so as to update the display informations DI corresponding to the electronic label units 141, 143, 145, 151, 153 and 155 through the database. In other embodiments, the server 10 can be coupled to the database 30 through an LAN (local area network), which the invention is not limited to. The server 10 can receive a remote instruction and output the display data to the control unit 110 according to the remote instruction. By means of the display information DI sent by the control unit 110, the display frame of partial, whole or one of the electronic label units 141, 143, 145, 151, 153 and 155 is controlled.

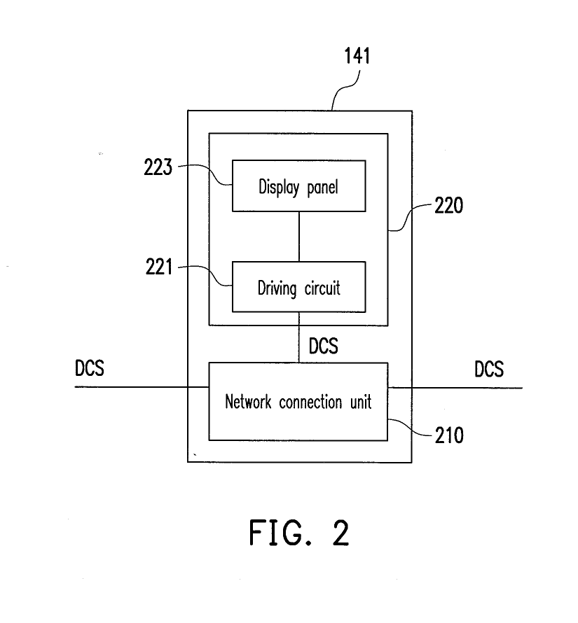

FIG. 2 is a schematic circuit diagram of an electronic label unit according to an embodiment of the invention. Referring to FIGS. 1 and 2, the electronic label unit 141 is taken as an example, while the rest electronic label units (such as 143, 145, 151, 153 and 155) can be analogically deducted for understanding. In the embodiment, the electronic label unit 141 includes a network connection unit 210 and a display unit 220. The display unit 220 includes a driving circuit 221 and a display panel 223. The network connection unit 210 of the electronic label unit 141 is coupled to the network connection unit 210 of the adjacent electronic label unit 143 and the second net unit 131. The driving circuit 221 is coupled to the display panel 223 and the network connection unit 210 to receive the display control signal DCS through the network connection unit 210 and drive the display panel 223 for displaying according to the corresponding display control signal DCS. The display panel 223 herein can be a liquid crystal display panel or an electrophoretic display panel, which the invention is not limited to. The address (0×0010) corresponding to the electronic label unit 141 can be saved at the network connection unit 210 or the driving circuit 221.

In more details, if the address corresponding to the electronic label unit 141 is saved at the network connection unit 210, when the network connection unit 210 receives the display control signal DCS, it is judged whether or not the received one is the corresponding display control signal DCS. If it is the corresponding display control signal DCS, the signal is transmitted to the driving circuit 221; if it is not the corresponding display control signal DCS, the signal is transmitted to the electronic label unit 143.

On the other hand, if the address corresponding to the electronic label unit 141 is saved at the driving circuit 221, when the network connection unit 210 receives the display control signal DCS, the signal is transmitted to the driving circuit 221 so as it is judged through the driving circuit 221 whether or not the received one is the corresponding display control signal DCS. If it is the corresponding display control signal DCS, the driving circuit 221 would drive the display panel 223 according to the display control signal DCS; if it is not the corresponding display control signal DCS, the driving circuit 221 would transmit the display control signal DCS through the network connection unit 210 to the electronic label unit 143. Or, when the network connection unit 210 receives the display control signal DCS, the signal is transmitted to the driving circuit 221 and the electronic label unit 143. If it is the corresponding display control signal DCS, the driving circuit 221 would drive the display panel 223 according to the display control signal DCS; if it is not the corresponding display control signal DCS, the driving circuit 221 would do nothing regardless the display control signal DCS.

In summary, the electronic label system in the embodiment of the invention uses a wired communication interface as the communication interface between the second net unit and the electronic label units so as to reduce the cost of the electronic label system.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. An electronic label system, comprising:
a control unit, configured for sending out a display information;
a first net unit, coupled to the control unit for converting the display information into a wireless display signal;
a second net unit, coupled to the first net unit for receiving the wireless display signal and outputting a display control signal; and
a plurality of electronic label units, coupled in series to the second net unit to receive the display control signal and to respectively display according to the corresponding display control signal.

2. The electronic label system as claimed in claim 1, wherein each of the electronic label units comprises:
a network connection unit, wherein the network connection unit of each of the electronic label units is coupled to the network connection unit of the adjacent electronic label unit or the second net unit; and
a display unit, coupled to the network connection unit to receive the display control signal through the network connection unit and display according to the display control signal.

3. The electronic label system as claimed in claim 2, wherein the display unit comprises:
a display panel; and
a driving circuit, coupled to the display panel and the network connection unit to drive the display panel according to the display control signal.

4. The electronic label system as claimed in claim 3, wherein the display panel is one of a liquid crystal display panel and an electrophoretic display panel.

5. The electronic label system as claimed in claim 1, wherein the electronic label units are respectively corresponding to an address.

6. The electronic label system as claimed in claim 5, wherein the second net unit sends out an address setting instruction and a starting address so that the electronic label units sequentially set the corresponding address respectively according to the coupling relationship.

7. The electronic label system as claimed in claim 6, wherein the address range of the electronic label units are corresponding to the quantity of connected address lines of the electronic label units.

8. The electronic label system as claimed in claim 5, wherein the electronic label units are respectively corresponding to a fixed address.

9. The electronic label system as claimed in claim 1, wherein the first net unit is coupled to the control unit through one of an Ethernet network, an internal integrated circuit (I2C) interface, a serial peripheral interface (SPI), an RS232 interface and an ARM bus.

10. The electronic label system as claimed in claim 9, wherein the control unit is coupled to a server through the Ethernet network so as to obtain the display information corresponding to each of the electronic label units from the server.

11. The electronic label system as claimed in claim 10, wherein the server is coupled to a database through a virtual private-area network so as to update the display information corresponding to each of the electronic label units through the database.

12. The electronic label system as claimed in claim 11, wherein the virtual private-area network is established in wide-area network.

13. The electronic label system as claimed in claim 1, wherein the second net unit is coupled to the first net unit through one of a WiFi protocol, a ZigBee protocol and a third generation (3G) mobile communications protocol.

14. The electronic label system as claimed in claim 1, wherein the electronic label units are coupled in series to the second net unit through one of an internal integrated circuit (I2C) interface, a serial peripheral interface (SPI), an RS232 interface and an ARM bus.
